(19) United States
(12) Patent Application Publication
(10) Pub. No.: US 2026/0274074 A1
(43) Pub. Date: Sep. 17, 2026

(54) METHOD AND SYSTEM FOR PERSONALIZATION OF INFOTAINMENT SYSTEM

(71) Applicant: TVS MOTOR COMPANY LIMITED, Chennai (IN)

(72) Inventors: Mazumdar Dipanjan, Chennai (IN); Kalpana Valavanur Umasankar, Chennai (IN)

(73) Assignee: TVS MOTOR COMPANY LIMITED, Chennai (IN)

(21) Appl. No.: 18/869,094

(22) PCT Filed: May 24, 2023
(86) PCT No.: PCT/IN2023/050492

§ 371 Date: Nov. 25, 2024

(30) Foreign Application Priority Data
May 24, 2022 (IN) 202241029721

(51) Int. Cl. B60K 35/65; B60K 35/10; B60K 35/22; B60K 35/85

(52) U.S. Cl. CPC B60K 35/65; B60K 35/10; B60K 35/22; B60K 35/85; B60K 2360/151; B60K 2360/164; B60K 2360/573; B60K 2360/731

(57) ABSTRACT

A method and a system are for user interface personalization displayed on the instrument cluster. The system is configured to personalize the themes of the display unit of the instrument cluster. The personalization of themes comprises the wallpaper change and preference in colors, font type and size. The personalization can be achieved in different means. The user can choose the customized image as an infotainment wallpaper. An original equipment manufacturer (OEM) shall provide the pre-defined themes in the mobile application. The user shall have an option to choose the themes provided by the OEM.

### FIELD OF THE INVENTION

The present subject matter is related, in general to infotainment systems, and more particularly, but not exclusively to a method and system for customization and personalization of content displayed on a infotainment system.

### BACKGROUND OF THE INVENTION

With the evolution of combustion vehicles to electric vehicles, the user interface and the connected features are progressing exponentially. Specifically, the content displayed on instrument clusters or infotainment systems is static is not customizable. However, the users are unique and expecting the personalization and customization in the content being displayed on the infotainment systems of the vehicles. Conventional vehicles do not have an option to customize the infotainment system. Traditional infotainment systems lack the capability for customization comprising the content of the display, color schemes of the display, background image of the display, font size of the content, and the like.

Thus, there is a need and a requirement for displaying customized data on the speedometer. Further, the customization is not user specific and is not based on the user profile and behaviour of the user. Additionally, choosing and placement of specific widgets again is not based on the user profile. Particularly, for users with different age groups, the widgets and customizations are not user friendly in the current instrument clusters. Further, as multiple users may drive the same vehicle hence there is no option to customize the displayed content on the instrument cluster.

Traditional instrument clusters have predefined data is being provided to the customer, that is customer cannot access the data on requirement. In an embodiment, multiple themes are predefined in instrument cluster. After selected by the user, the selected theme will get showcased on the instrument cluster. However, challenge is to provide the instrument cluster system with an existing operating system. However, such OS based instrument clusters need high end processing capability. Further, if an existing vehicle of a user does not have instrument clusters need high end processing capabilities, then the user/rider has to buy the new vehicle to get these features. From manufacturing point of view, OS based instrument clusters is having complex configuration, high cost, thermal management of OS based cluster is challenging

Thus, there is a need of having customization and personalization of the data in conventional instrument clusters (TFT Based instrument clusters) such that the user of the vehicle would not have to pay extra to get additional features.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to embodiments illustrated herein, there is provided a method and a system for user interface personalization displayed on the instrument cluster. The system is configured to personalize the themes of the display unit of the instrument cluster. The personalization of themes comprises the wallpaper change and preference in colors, font type and size. The personalization can be achieved in different means. The user can choose the customized image as an infotainment wallpaper. The OEM shall provide the pre-defined themes in the mobile application. The user shall have an option to choose the themes provided by the OEM.

The claimed method discloses a method for personalization of an infotainment system. The method comprises receiving, by an electronic device, a first input from a user indicative of selection one or more personalization associated with a user interface of the infotainment system. The method comprises generating, by the electronic device, a preview of the selected one or more personalization on the user interface of a display screen of the infotainment system. The method comprises receiving, by the electronic device, a second input from the user indicative of a confirmation to apply the selected one or more personalization. The method comprises transmitting, by the electronic device, the selection one or more personalization associated with the user interface of the infotainment system to a control unit of a vehicle. In an embodiment, the control unit is configured to apply the selected one or more personalization to the infotainment system of the vehicle.

The claimed system personalizes an infotainment system. The system comprises an electronic device, and an infotainment system. The electronic device configured to receive a first input from a user indicative of selection one or more personalization associated with a user interface of the infotainment system. The electronic device configured to generate a preview of the selected one or more personalization on the user interface of a display screen of the infotainment system. The electronic device configured to receive a second input from the user indicative of a confirmation to apply the selected one or more personalization. The electronic device configured to transmit the selection one or more personalization associated with the user interface of the infotainment system to a control unit of a vehicle. The infotainment system configured to receive the one or more personalization associated with the user interface of the infotainment system from the control unit of the vehicle, wherein the control unit is configured to apply the selected one or more personalization to the infotainment system of the vehicle.

### BRIEF DESCRIPTION OF THE DRAWINGS

The present invention will become more fully understood from the detailed description given herein below and the accompanying drawings which are given by way of illustration only, and thus are not limitative of the present invention, and wherein

FIG. 1 illustrates a system environment for implementation of the disclosed invention.

FIGS. 2A and 2B illustrates an architecture for personalization and customization of content displayed on infotainment systems, in accordance with an embodiment of the present subject matter.

FIGS. 3A and 3B illustrates another architecture for personalization and customization of content displayed on infotainment systems, in accordance with an embodiment of the present subject matter.

FIG. 4 illustrates a flowchart of a method for personalization and customization of content displayed on infotainment systems, in accordance with an embodiment of the present subject matter.

FIG. 5 illustrates a system diagram for personalization of an infotainment system, in accordance with an embodiment of the present subject matter.

FIG. 6 illustrates a block diagram of an electronic device for personalization of an infotainment system, in accordance with an embodiment of the present subject matter.

FIG. 7 illustrates a flowchart of a method for personalization of the infotainment system, in accordance with an embodiment of the present subject matter.

### DETAILED DESCRIPTION OF THE DRAWINGS

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention now will be described more fully hereinafter with different embodiments. This invention may, however, be embodied in many different forms and should not be construed as limited to the embodiments set forth herein; rather those embodiments are provided so that this disclosure will be thorough and complete, and fully convey the scope of the invention to those skilled in the art.

The present invention is illustrated with a motorcycle type vehicle. However, a person skilled in the art would appreciate that the present invention is not limited to a motorcycle type vehicle and certain features, aspects and advantages of embodiments of the present invention can be used with other types of two wheelers such as scooter type vehicle, step thru, and the like. In an embodiment, the scooter type vehicle comprises a low floorboard type vehicle and the term scooter as used herein should not be inferred to restrict the maximum speed, the displacement amount or the like of the vehicle.

The object of the present subject matter is to provide customization and personalization options to infotainment system without the high-end processing capabilities. Another aspect of the present subject matter is to provide customization and personalization of the content displayed on the instrument cluster based on the profile of the user. In an embodiment, based on the user's age, geography, gender and preferences font, colours, schemes and content will be different for the users. Yet another object of the present subject matter is to provide a low cost TFT cluster or a non-OS based infotainment system with customization functionalities. Yet another object of the present subject matter is to provide personalization and customization features in low cost and simple TFT based cluster.

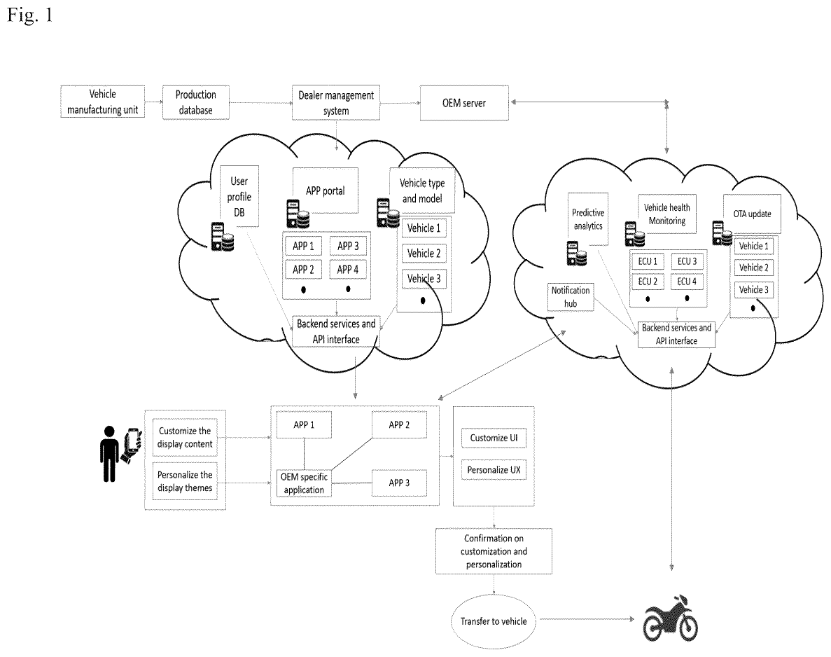

FIG. 1 illustrates a system environment for implementation of the disclosed invention.

The infotainment system comprises a control unit, display unit and a wireless transceiver coupled to the controller. Further, the infotainment system comprises a firmware application which can fetch data from other applications in a smart device not limited to contacts, incoming calls, incoming messages, device locations, GPS data. The application has a feature of content suggestion, content customization and user interface personalization. The instrument panel mounted in the vehicle wirelessly communicates the vehicle level data to an application in a smart device not limited to Bluetooth, Infrared, near field communication, ultra-band, ZigBee and Wi-Fi.

The infotainment system further comprises a memory, a control unit, display unit, a wireless transceiver, i/o unit, a content suggestion unit, a content customization unit. The content customization unit is configured to customize the content of information available on the display unit

The customization is possible in different ways. The user can choose the required widgets and interfaces, need to be displayed. The OEM shall have an option to customize the content based on user driving behavior, geography location and vehicle conditions.

Further, a user interface personalization unit is configured to personalize the themes of the display unit. The personalization of themes comprises the wallpaper change and preference in colors, font type and size. The personalization can be achieved in different means. The user can choose the customized image as an infotainment wallpaper. The OEM shall provide the pre-defined themes in the mobile application. The user shall have an option to choose the themes provided by the OEM.

The user computing device may refer to a computing device used by a user. The user computing device may be comprised of one or more processors and one or more memories. The one or more memories may include computer readable code that may be executable by the one or more processors to perform predetermined operations. Further, the user computing device may be configured to present a user-interface to the user for customizing the display on the instrument cluster/infotainment unit. Examples of the user computing device may include, but are not limited to, a personal computer, a laptop, a personal digital assistant (PDA), a mobile device, a tablet, or any other computing device.

The communication network may correspond to a communication medium through which the user computing device, the OEM server 108 and the other enties may communicate with each other. Such a communication may be performed, in accordance with various wired and wireless communication protocols. Examples of such wired and wireless communication protocols include, but are not limited to. Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G, 5G, and 6G cellular communication protocols, and/or Bluetooth (BT) communication protocols. The communication network may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In an embodiment, a mobile app is installed in the user computing device. The OEM specific mobile application plays a vital role in personalization and customization of the content displayed on the instrument cluster. The application shall have an option to personalize the entire themes, wallpaper preferences from the user gallery and other third-party applications, font type, size and color. The customization of content, location of widgets and other apps will be available in the mobile application.

OEM server may refer to a computing device or a software framework hosting an application or a software service. In an embodiment, the transaction server 108 may be implemented to execute procedures such as, but not limited to, programs, routines, or scripts stored in one or more memories for supporting the hosted application or the software service. In an embodiment, the hosted application or the software service may be configured to perform one or more predetermined operations. The transaction server 108 may be realized through various types of application servers such as, but are not limited to, a Java application server, a NET framework application server, a Base4 application server, a PUP framework application server, or any other application server framework. In an embodiment, a telematics system may have direct communication with the OEM server.

The OEM server is configured to collect the vehicle data for monitoring the health of the vehicle and do predictive analysis to reduce the breakdown. The user information and vehicle information will get collated at the OEM server for doing the customization. In an embodiment, the customization of content will happen directly based on user driving behavior, vehicle health condition and the geography of that location. In an embodiment, the wallpaper of the instrument cluster is customizable where the user can update the background of their cluster.

The wallpaper can be changed via two methods. The user can either transfer the image from their local gallery to the cluster or they can download from the OEM server and upload in the cluster. The app and OEM server render the image making it suitable according to our cluster resolutions while the cluster superimposes the functional screens like odometer, speedometer, navigation, and the like over the image changing the cluster wallpaper according to the user's choice.

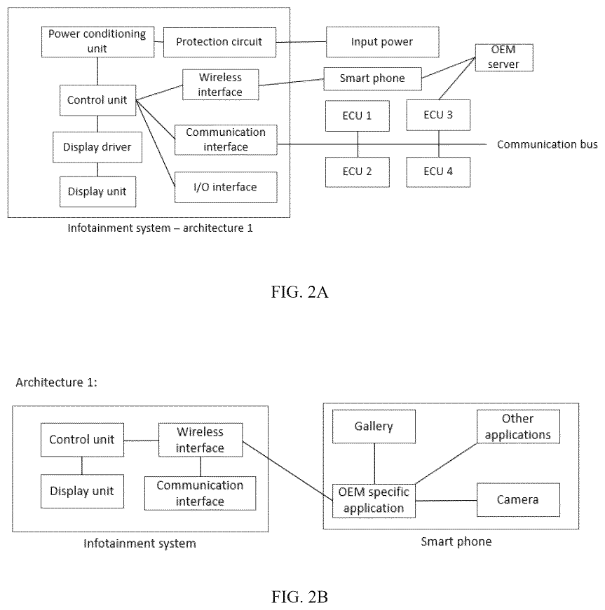

FIGS. 2A and 2B illustrates an architecture for personalization and customization of content displayed on infotainment systems, in accordance with an embodiment of the present subject matter.

Referring to FIGS. 2A and 2B, a vehicle communication bus is a specialized internal communications network that interconnects different ECUs inside a vehicle. The GPS tracking system communicates in a vehicle bus with different controllers namely, battery management system (BMS) controller, Motor controller, instrument cluster controller, Vehicle control unit, Body Control Unit, and ABS controller. The communication between controllers can be communicated through different networks not limited to Controller Area Network (CAN), Local Interconnect Network (LIN), gateway, Ethernet, and K-line. The speedometer consists of microcontroller, protection circuitry, power regulating circuits and communication interfaces. The circuitry also contains other analog and digital interfaces.

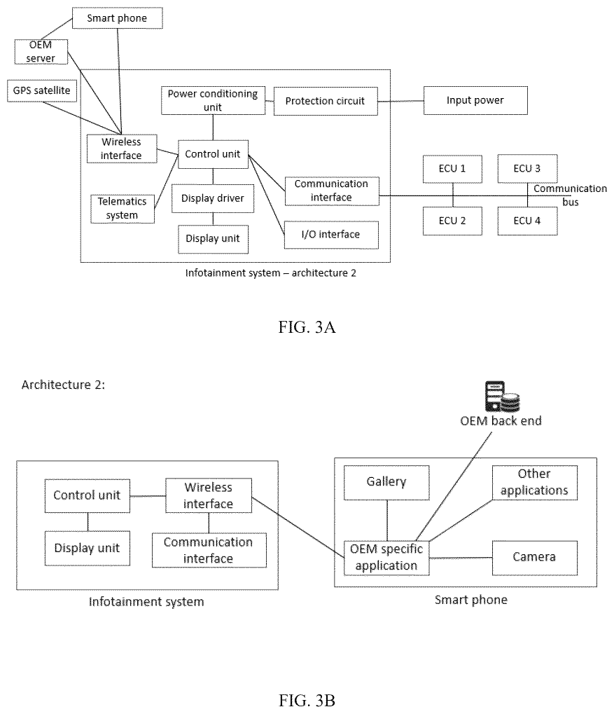

FIGS. 3A and 3B illustrates another architecture for personalization and customization of content displayed on infotainment systems, in accordance with an embodiment of the present subject matter.

Referring to FIGS. 3A and 3B, a vehicle communication bus is a specialized internal communications network that interconnects different ECUs inside a vehicle. The GPS tracking system communicates in a vehicle bus with different controllers namely, battery management system (BMS) controller, Motor controller, instrument cluster controller, Vehicle control unit, Body Control Unit, and ABS controller. The communication between controllers can be communicated through different networks not limited to Controller Area Network (CAN), Local Interconnect Network (LIN), gateway, Ethernet, and K-line. The speedometer consists of microcontroller, protection circuitry, power regulating circuits and communication interfaces. The circuitry also contains other analog and digital interfaces.

In an embodiment, the elements of the GPS tracking unit are integrated on the same PCB of the speedometer. A speedometer consists of a control unit, display unit, an accelerometer, a gyroscope, a global position sensor receiver, a cellular module, an in-vehicle network transceiver, and a wireless transceiver coupled to the controller: comprises an antenna for GPS and cellular module.

In an embodiment, an accelerometer is fixed to get acceleration along the X, Y, and Z-axes of the vehicle. The mounting of an accelerometer concerning the ground plane of reference is the main element for tuning the thresholds.

Further, the vehicle comprises gyroscopes, or gyros, that are devices that measure or maintain rotational motion. The gyroscope maintains its level of effectiveness by being able to measure the rate of rotation around a particular axis. Further, the vehicle comprises a GPS receiver is an L-band radio processor capable of solving the navigation equations to determine the user position, velocity, and precise time (PVT), by processing the signal broadcasted by GPS satellites.

Further, the vehicle comprises Cellular modules that are devices that allow for the machine to machine (M2M) connectivity across a variety of communication networks. Everything from phones, cars, eBook readers, and vending machines can have cellular modules installed in them. Different types of cellular modules are 2G, 3G, and 4G. Cellular data transmission speeds go up from 2G where speeds are rated in a few tens of kilobits per second (Kbps) to the current release of 4G LTE of 100 Megabits per second (Mbps).

The infotainment system is configured to provide options to customize and personalize the information getting displayed on the speedometer. The customization of infotainment system comprises the following parameters, such as content displayed on the speedometer, widgets displayed on the individual drive modes, vehicle information related widgets. In an embodiment, the, vehicle information related widgets comprise a battery SOC, Odometer, Average speed, trip meter, predicted range, distance to empty, fuel/energy consumption, fuel/energy efficiency, tyre pressure status, and the like. The customization of infotainment system further comprises vehicle notifications, such as temperature alerts, malfunction alerts, service reminders, charging reminders.

Further, connected interface related widgets may be customized such as smart phone—signal strength, battery level, weather info—temperature, weather status and icon. Additionally, connected notifications includes incoming caller alert, message alert, missed call alert, geo-fence alert, email notifications are also customized by the disclosed system.

In an embodiment, the personalization of infotainment system includes the following parameters background themes—skin of the UI, colours used in the screens, font type and size,

In an embodiment, the background themes may be selected from the smart phone. The image shall be selected from any other application such as gallery, camera etc. In an embodiment, the user shall have an option to download the pre-defined OEM themes to use it as wallpaper.

The customization shall be triggered in different means. The user shall choose their own content for the display unit. The OEM shall have an option to update the content based on individual user driving behaviour and the geography of the specific location. The personalization of the themes helps the user to associate with the vehicle. The customization and personalization option in the infotainment system helps the user to have comfortable ride with enhanced ergonomic viewpoint. For an example, the option to change the font size helps the customer segment consisting of older persons. Further, the option to personalize the backdrop enhance the riding experience among the young customer segments. Further, the option to customize the content helps to prioritize the vehicle information and notifications while riding

Additionally, the option of personalization and customization of infotainment system can be performed in conjunction with the OEM server. The OEM establishes backend services, vehicle and user smart devices which forms an ecosystem. The user information, vehicle information gets collated and utilized for the enhancement of infotainment system. The disclosed invention providing option to the user for customizing the user interaction on the display.

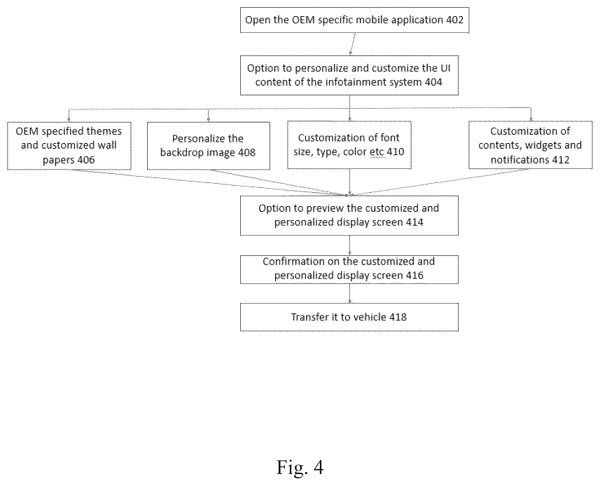

FIG. 4 illustrates a flowchart of a method for personalization and customization of content displayed on infotainment systems, in accordance with an embodiment of the present subject matter.

At step 402, the rider open the OEM specific mobile application. At step 404, the rider interacts with the OEM specific mobile application and has the options to personalize and customize the user interface content of the infotainment system. At step 406, the rider may select OEM specified themes and customized wallpapers. At step 408, the rider may personalize the backdrop image of the instrument cluster/infotainment unit.

At step 410, the rider may customize font size, font type, font colour, and the like associated with the content being displayed on the instrument cluster/infotainment unit. At step 412, the rider may perform customization of the contents, widgets, and the notifications being displayed on the instrument cluster/infotainment unit. At step 414, the rider has the option to preview the one or more customizations requested by the rider. At step 416, the rider provides a confirmation on the customization and personalization of the display screen. At step 418, further the suggested customization and personalization are transferred to the vehicle so that customized data can be viewed on the instrument cluster/infotainment unit.

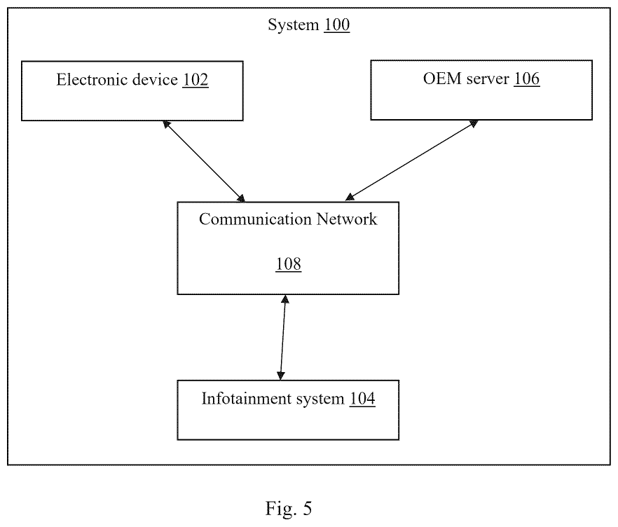

FIG. 5 illustrates a system diagram 100 for personalization of an infotainment system, in accordance with an embodiment of the present subject matter. The system diagram 100 comprises an electronic device 102, an OEM server 106, an infotainment system 104 and a communication network 108. The electronic device 102, the OEM server 106, and the infotainment system 104 are communicatively coupled with each other via the communication network 108. In an embodiment, the electronic device 102 may communicate with the infotainment system 104 using one or more protocols such as, but not limited to, Open Database Connectivity (ODBC) protocol and Java Database Connectivity (JDBC) protocol.

In an embodiment, the electronic device 102 may refer to a computing device used by a user. The electronic device 102 may comprise of one or more processors and one or more memories. The one or more memories may include computer readable code that may be executable by the one or more processors to perform predetermined operations. In an embodiment, the electronic device 102 may present a web user interface or a mobile application user interface to receive inputs from a user and to transmit data to the infotainment system 104. Example web user interfaces presented on the electronic device 102 to display customizations/personalization to be applied on the infotainment system 104. Examples of the user-computing device 106 may include, but are not limited to, a personal computer, a laptop, a personal digital assistant (PDA), a mobile device, a tablet, or any other computing device.

The electronic device 102 may be configured to receive a first input from a user indicative of selection one or more personalization associated with a user interface of the infotainment system. Further, the electronic device 102 may be configured to generate a preview of the selected one or more personalization on the user interface of a display screen of the infotainment system. Further, the electronic device 102 may be configured to receive a second input from the user indicative of a confirmation to apply the selected one or more personalization. Further, the electronic device 102 may be configured to transmit the selection one or more personalization associated with the user interface of the infotainment system to a control unit of a vehicle. In an embodiment, the control unit is configured to apply the selected one or more personalization to the infotainment system of the vehicle

The infotainment system 104 may correspond to an instrument cluster on a vehicle. The infotainment system 104 may comprise a display screen such as a TFT display screen and the may have low processing capabilities. The infotainment system 104 may have a plurality of tell-tale lights that may glow when a pre-defined set of conditions are satisfied. In an embodiment, the plurality of tell-tale lights may include hazard tell tale lamp, TSL, ISS tell tale lamp, ABS tell tale lamp, and the like.

In an embodiment, the communication network 108 may correspond to a communication medium through which the electronic device 102, and the infotainment system 104 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared IR), IEEE 802.11, 802.16, 2G, 3G, 4G, 5G, 6G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

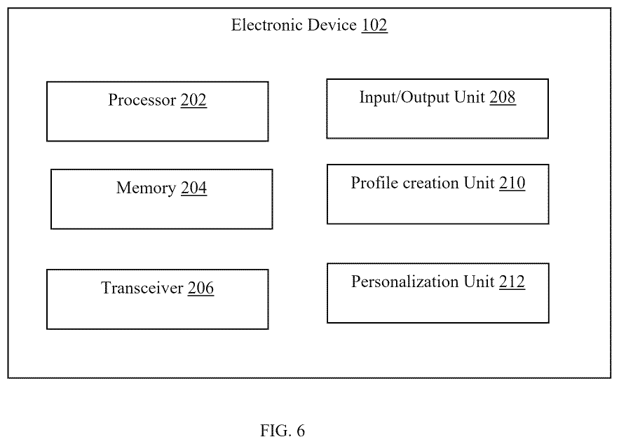

FIG. 6 illustrates a block diagram of an electronic device for personalization of an infotainment system, in accordance with an embodiment of the present subject matter.

In an embodiment, the electronic device 102 includes a processor 202, a memory 204, a transceiver 206, an input/output unit 208, a profile creation unit 210, and a personalization unit 212. The processor 202 may be communicatively coupled to the memory 204, the transceiver 206, the input/output unit 208, the profile creation unit 210, and the personalization unit 212. The transceiver 206 may be communicatively coupled to the communication network 108.

The processor 202 may include suitable logic, circuitry, interfaces, and/or code that may be configured to execute a set of instructions stored in the memory 204. The processor 202 may be implemented based on a number of processor technologies known in the art. The processor 202 may work in coordination with the transceiver 206, the input/output unit 208, the profile creation unit 210, and the personalization unit 212 to personalize the infotainment system. Examples of the processor 202 include, but not limited to, an X86-based processor, a Reduced Instruction Set Computing (RISC) processor, an Application-Specific Integrated Circuit (ASIC) processor, a Complex Instruction Set Computing (CIBC) processor, and/or other processor.

The memory 204 may include suitable logic, circuitry, interfaces, and/or code that may be configured to store the set of instructions, which are executed by the processor 202. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card.

The transceiver 206 may include suitable logic, circuitry, interfaces, and/or code that may be configured to receive rider information and transmit personalization selections to the control unit of the vehicle, via the communication network. The transceiver 206 may implement one or more known technologies to support wired or wireless communication with the communication network. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

The input/output unit 208 may include suitable logic, circuitry, interfaces, and/or code that may be configured to receive a first input from a user indicative of selection one or more personalization associated with a user interface of the infotainment system. The input/output unit 208 may be configured to receive a second input from the user indicative of a confirmation to apply the selected one or more personalization. The input/output unit 208 may include various input and output devices that are configured to communicate with the processor 202. Examples of the Input devices include, but are not limited to, a keyboard, a mouse, a joystick, a touch screen, an image sensor for gesture recognition, a microphone, a camera, and/or a docking station. Examples of the output devices include, but are not limited to, a display screen and/or a speaker.

The profile creation unit 210 may include suitable logic, circuitry, interfaces, and/or code that may be configured to create a profile of the user based on the user riding characteristics, user demographics, location of vehicle, and the like.

The personalization unit 212 may include suitable logic, circuitry, interfaces, and/or code that may be configured to automatically identify the one or more personalization based on a rider profile of the vehicle, weather conditions, speed of the vehicle, acceleration of the vehicle, driving pattern of the rider of the vehicle, rider's age, a location of the vehicle, a gender of the rider, vehicle health condition.

In operation, the electronic device 102 is communicatively coupled with the control unit using a wired communication medium or a wireless communication medium. In an embodiment, the infotainment system has minimal processing capabilities and is a low cost device and is a non-OS based infotainment system. In an embodiment, the infotainment system comprises a first application configured to enable personalization of the infotainment system. In an embodiment, the application is configured to receive information from the electronic device, wherein the information comprises contacts, incoming calls, incoming messages, electronic device location, and GPS data. Further, in an embodiment, the electronic device comprises a second application configured to receive personalization inputs and transmit the same to the control unit.

The profile creation unit 210 may be configured to create a rider profile based on one or more demographic details of the rider, riding pattern of the rider, social media usage of the rider, and the like. For example, the rider profile may include 22 years of age, Male rider, Spanish language, faster acceleration driving pattern, high speed driving pattern living in San Hose and the vehicle age is 6 years.

Once the profile is created, the personalization unit 212 may be configured to automatically identify one or more personalization based on a rider profile of the vehicle, weather conditions, speed of the vehicle, acceleration of the vehicle, driving pattern of the rider of the vehicle, rider's age, a location of the vehicle, a gender of the rider, vehicle health condition. For example, the identified customizations may language of content should be Spanish, display of weather widget, color of speedometer should be red while accelerating and background wallpaper should be “Winchester Mystery House” wallpaper which is located at San Hose.

Once the personalization is identified then the personalization may be provided/displayed to the rider as recommendations. In an embodiment, one or more personalization recommendations are different for different riders of the vehicle. Further, a first input is received from a user indicative of selection one or more personalization associated with a user interface of the infotainment system. For example, the user may select the weather widget and the wallpaper personalization or may also choose any other personalization as per his/her choice. In an embodiment, the first input and second input being provided using at least one of a touch input, a voice input, and a gesture input. For example, the rider may provide touch input for selection of the displayed personalization.

In an embodiment, as discussed above, the one or more personalization comprises one or more OEM specified themes, background image, font size, font type, font color, widgets, notifications, screen resolution, brightness, type of content In an embodiment, the one or more personalization is stored centrally on an OEM server or locally on the electronic device. For example, the rider may choose a locally stored wallpaper on the electronic device as the background for the infotainment system,

Once the selection is done using the first input, then a preview of the selected one or more personalization is generated on the user interface of a display screen of the infotainment system. Further, a second input is received from the user indicative of a confirmation to apply the selected one or more personalization. For example, the user may click on the “CONFIRM” button on the user interface or provide a voice input by saying “OK APPLY”.

In response to the confirmation, the selection of the one or more personalization associated with the user interface of the infotainment system is transmitted by the transceiver to a control unit of a vehicle. In an embodiment, the control unit is configured to apply the selected one or more personalization to the infotainment system of the vehicle. In another embodiment, a third input may be received from the user to apply the one or more personalization automatically identified. For example, the user may say “APPLY RECOMMENDED PERSONLIZATION”

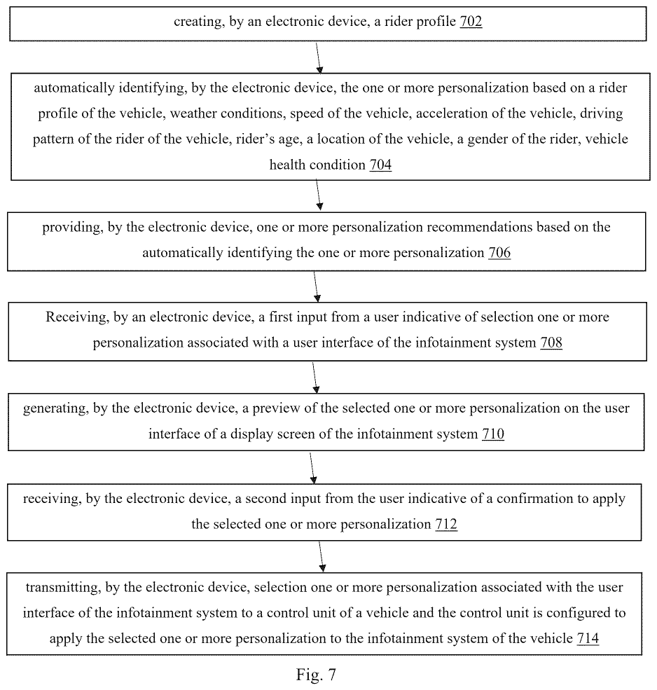

FIG. 7 illustrates a flowchart of a method for personalization of the infotainment system, in accordance with an embodiment of the present subject matter. At step 702, the electronic device 102 may be configured to create a rider profile based on one or more demographic details of the rider, riding pattern of the rider, social media usage of the rider, and the like. At step 704, the electronic device 102 may be configured to automatically identify the one or more personalization based on a rider profile of the vehicle, weather conditions, speed of the vehicle, acceleration of the vehicle, driving pattern of the rider of the vehicle, rider's age, a location of the vehicle, a gender of the rider, vehicle health condition. For example, of the rider is driving in a rainy condition then the wallpaper may be automatically changed to water droplets. If the rider is driving beyond a recommended speed limit, then the background color of the infotainment system can be changed to red and the font size of the speed can be increased.

At step 706, the electronic device 102 may be configured to provide one or more personalization recommendations based on the automatically identifying the one or more personalization. For example, rather than directly personalizing the infotainment system, the system can provide recommendation to the rider and the rider can select from such displayed recommendations. At step 708, the electronic device 102 may be configured to receive a first input from a user indicative of selection one or more personalization associated with a user interface of the infotainment system. For example, the rider can select placement of the weather widget on the infotainment system and also change the font color of the speed dial by providing a touch input or by using a circular hand gesture.

At step 710, the electronic device 102 may be configured to generate a preview of the selected one or more personalization on the user interface of a display screen of the infotainment system. For example, after receiving the touch/gesture input, a preview of the suggested personalization may be displayed on the display screen of the electronic device so that the rider may either confirm or carry out further personalization if not liked. At step 712, the electronic device 102 may be configured to receive a second input from the user indicative of a confirmation to apply the selected one or more personalization. For example, the second input may be a touch input on a “confirm” button displayed on the electronic device 102. At step 714, the electronic device 102 may be configured to transmit the selection of one or more personalization associated with the user interface of the infotainment system to a control unit of a vehicle. In an embodiment, the control unit is configured to apply the selected one or more personalization to the infotainment system of the vehicle.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

### Advantages

The disclosed invention provides a method and system for customization and personalization options of infotainment system without the high-end processing capabilities. Compared to OS cluster, TFT Cluster are low cost. So, in low cost the rider will get the customization options from present invention. Further, based on the user profile and user characteristics the personalization and customization of the instrument cluster is achieved. Existing non-OS based instrument clusters are enabled with additional customization functionality by implementing the current invention. The claimed system and method automatically identify the personalization and apply to a non-OS based cluster/infotainment system by using the electronic device

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

A description of an embodiment with several components in communication with a other does not imply that all such components are required, On the contrary, a variety of optional components are described to illustrate the wide variety of possible embodiments of the invention,

Finally, the language used in the specification has been principally selected for readability and instructional purposes, and it may not have been selected to delineate or circumscribe the inventive subject matter and is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1.-21. (canceled)

22. A method for personalization of an infotainment system, the method comprising:
receiving, by an electronic device, a first input from a user indicative of selection one or more personalization associated with a user interface of the infotainment system;
generating, by the electronic device, a preview of the selected one or more personalization on the user interface of a display screen of the infotainment system;
receiving, by the electronic device, a second input from the user indicative of a confirmation to apply the selected one or more personalization; and
transmitting, by the electronic device, the selection one or more personalization associated with the user interface of the infotainment system to a control unit of a vehicle, wherein the control unit is configured to apply the selected one or more personalization to the infotainment system of the vehicle.

23. The method as claimed in claim 22, wherein the one or more personalization comprises one or more original equipment manufacturer (OEM) specified themes, background image, font size, font type, font color, widgets, notifications, screen resolution, brightness, type of content.

24. The method as claimed in claim 22, wherein the one or more personalization is stored centrally on an original equipment manufacturer (OEM) server or locally on the electronic device.

25. The method as claimed in claim 22, automatically identifying, by the electronic device, the one or more personalization based on a rider profile of the vehicle, weather conditions, speed of the vehicle, acceleration of the vehicle, driving pattern of the rider of the vehicle, rider's age, a location of the vehicle, a gender of the rider, vehicle health condition.

26. The method as claimed in claim 22, providing, by the electronic device, one or more personalization recommendations based on the automatically identifying the one or more personalization.

27. The method as claimed in claim 22, receiving, by the electronic device, a third input to apply the automatically identified the one or more personalization.

28. The method as claimed in claim 22, wherein the infotainment system has minimal processing capabilities and is a non-OS based infotainment system.

29. The method as claimed in claim 22, wherein the infotainment system comprises a first application configured to enable personalization of the infotainment system, wherein the application is configured to receive information from the electronic device, wherein the information comprises contacts, incoming calls, incoming messages, electronic device location, and GPS data.

30. A system to personalize an infotainment system, the system comprising:
an electronic device configured to:
receive a first input from a user indicative of selection one or more personalization associated with a user interface of the infotainment system;
generate a preview of the selected one or more personalization on the user interface of a display screen of the infotainment system;
receive a second input from the user indicative of a confirmation to apply the selected one or more personalization;
transmit the selection one or more personalization associated with the user interface of the infotainment system to a control unit of a vehicle; and
an infotainment system configured to:
receive the one or more personalization associated with the user interface of the infotainment system from the control unit of the vehicle, wherein the control unit is configured to apply the selected one or more personalization to the infotainment system of the vehicle.

31. The system as claimed in claim 30, wherein at least one of an original equipment manufacturer (OEM) server and the electronic device configured to store the one or more personalization.

32. The system as claimed in claim 30, wherein the first input and second input being provided using at least one of a touch input, a voice input, and a gesture input.

33. The system as claimed in claim 30, wherein the one or more personalization comprises one or more original equipment manufacturer (OEM) specified themes, background image, font size, font type, font color, widgets, notifications, screen resolution, brightness, type of content.

34. The system as claimed in claim 30, wherein at least one of the electronic device and an original equipment manufacturer (OEM) server is configured to automatically identify one or more personalization based on a rider profile of the vehicle, weather conditions, speed of the vehicle, acceleration of the vehicle, driving pattern of the rider of the vehicle, rider's age, a location of the vehicle, a gender of the rider, vehicle health condition.

35. The system as claimed in claim 30, wherein the electronic device is configured to:
provide one or more personalization recommendations based on the automatically identifying the one or more personalization; and
receive a third input to apply the automatically identified the one or more personalization.

36. The system as claimed in claim 30, wherein the infotainment system comprises a first application configured to enable personalization of the infotainment system, wherein the application is configured to receive information from the electronic device, wherein the information comprises contacts, incoming calls, incoming messages, electronic device location, and GPS data and wherein the electronic device comprises a second application configured to receive personalization inputs and transmit the same to the control unit.
